(19) United States
(12) Patent Application Publication
(10) Pub. No.: US 2025/0261137 A1
(43) Pub. Date: Aug. 14, 2025

(54) TIMING GRID FOR DECENTRALIZED SYNCHRONIZATION IN WIRELESS DISTRIBUTED NETWORKS

(71) Applicant: SILVUS TECHNOLOGIES, INC., Los Angeles, CA (US)

(72) Inventors: Mansour Rachid, Los Angeles, CA (US); Bradley Rainbolt, Detroit, MI (US); Joseph Abraham Farkas, Merrimack, NH (US); Brandon Pierce Hombs, Merrimack, NH (US)

(21) Appl. No.: 18/438,100

(22) Filed: Feb. 9, 2024

(51) Int. Cl. H04W 56/00

(52) U.S. Cl. CPC H04W 56/001; H04W 56/0045

(57) ABSTRACT

Systems and methods may include one or more devices associated with a distributed network. In some examples, a device may include a memory. A device may include an antenna. A device may include a transceiver. A device may include one or more hardware processors configured to receive a timing initialization packet from a node of the plurality of nodes, determine an operating frequency, and determine a timing grid based at least in part on the timing initialization packet. The timing grid may include permitted times the first node can perform an action. One or more processors of a device may be configured to perform an action at a permitted time of the timing grid.

### STATEMENT REGARDING FEDERALLY SPONSORED R&D

This invention was made with government support under U.S. Government contract HR00112190043 awarded by DARPA. The government may have certain rights in the invention.

### FIELD OF THE DISCLOSURE

The subject matter disclosed herein relates to the field of relay communication and distributed networks.

### BACKGROUND

Distributed networks are widely deployed to provide various types of wireless communication (e.g., voice, data, multimedia services, etc.) to multiple users. As the demand for various types of wireless communication grows, there lies a challenge to implement efficient and robust communication systems.

Possible goals of systems that employ relay communication and/or distributed networks may include range extension, anti-jam capability, low probability of intercept (LPI) capability, low probability of detection (LDP) capability, and others. Potential challenges to achieving such goals may include jamming, terrain, obstacles in the environment, network congestion, and others. Accordingly, techniques which address these and other challenges may be beneficial.

### SUMMARY

In some aspects, the techniques described herein relate to a system for synchronizing transmission between nodes of a distributed network. The system can include a first node of a plurality of nodes in a communication network. The first node can include a memory, an antenna, a transceiver, and one or more hardware processors. The one or more hardware processors can be configured to receive a timing initialization packet from a second node of the plurality of nodes, determine an operating frequency, determine a timing grid based at least in part on the timing initialization packet, the timing grid including permitted times the first node can perform an action, and perform the action at a permitted time of the timing grid.

In some embodiments, to determine the operating frequency, the one or more hardware processors are configured to perform operating frequency synchronization with the second node. In some embodiments, the action includes estimating at least one of: a time of arrival of the timing initialization packet, one or more parameters associated with one or more channels of the communication network, or a phase of arrival off the timing initialization packet In some embodiments, the action includes calculating a received signal time. In some embodiments, the action includes transmission of a first packet to another node or cluster of nodes in the communication network. In some embodiments, the first packet is received by the first node during a non-permitted time of the timing grid. In some embodiments, the first packet is relayed by the first node from a stored location. In some embodiments, the operating frequency is a common operating frequency between the plurality of nodes in the communication network. In some embodiments, the timing initialization packet includes a flagged time to begin the timing grid. In some embodiments, a periodicity between permitted times of the timing grid is based on at least a geographic or communication distance between at least some of the plurality of nodes. In some embodiments, an earliest in time permitted time of the timing grid occurs after a first period of the periodicity.

In some aspects, the techniques described herein relate to a method for synchronizing transmission between nodes of a distributed network. The method can include receiving, by a first node of a plurality of nodes in a communication network, a timing initialization packet from a second node of the plurality of nodes. The method can include determining an operating frequency. The method can include determining a timing grid based at least in part on the timing initialization packet, the timing grid including permitted times the first node can perform an action. The method can include performing the action at a permitted time of the timing grid.

In some embodiments, determining the operating frequency includes performing operating frequency synchronization with the second node. In some embodiments, the action includes estimating at least one of: a time of arrival of the timing initialization packet, one or more parameters associated with one or more channels of the communication network, or a phase of arrival off the timing initialization packet. In some embodiments, the action includes calculating a received signal time. In some embodiments, the action includes transmission of a first packet to another node or cluster of nodes in the communication network. In some embodiments, the first packet is received by the first node during a non-permitted time of the timing grid. In some embodiments, the first packet is relayed by the first node from a stored location. In some embodiments, the operating frequency is a common operating frequency between the plurality of nodes in the communication network. In some embodiments, the timing initialization packet includes a flagged time to begin the timing grid, and a periodicity between permitted times of the timing grid is based on at least a geographic or communication distance between at least some of the plurality of nodes, a beginning of the periodicity at the flagged time.

### BRIEF DESCRIPTION OF THE DRAWINGS

To easily identify the discussion of any particular element or act, the most significant digit or digits in a reference number refer to the figure number in which that element is first introduced.

FIG. 1 illustrates an example networking device that may be part of one or more network environments described herein.

FIG. 2A illustrates an example distributed network cluster that may utilize timing grid systems and methods described herein.

FIG. 2B illustrates another example distributed network cluster that may utilize timing grid systems and methods described herein.

FIG. 2C illustrates an example communication environment in an example distributed network environment.

FIG. 3A illustrates an example timing grid that may be implemented on an example networking device, such as described herein.

FIG. 3B illustrates an example timing grid system that may be implemented by an example network environment, such as described herein.

FIG. 3C illustrates an example networking communication between example networking devices that may utilize timing grid systems and methods such as described herein.

FIG. 4 illustrates an example process for establishing a reference node timing grid.

FIG. 5 illustrates an example process for establishing a nonreference node timing grid.

FIG. 6 illustrates an example relaxed timing grid.

FIG. 7A illustrates an example communication between two distributed network clusters operating utilizing an example timing grid system and method such as described herein.

FIG. 7B illustrates an example delayed transmission in a distributed network based on an example relaxed timing grid.

FIG. 8 illustrates an example node relay process based on an example relaxed timing grid.

FIGS. 9A and 9B illustrate example use of a relaxed timing grid for an example reference node receiving signals from nonreference nodes of a node cluster.

FIG. 10 illustrates an example reference node reception using an example relaxed timing grid.

### DETAILED DESCRIPTION

Distributed wireless networks may contain groups of nodes (also referred to as a “node cluster,” “cluster of nodes,” or “cluster”). In some applications, it may be desirable for a node cluster to operate in concert. For example, a node cluster may transmit signals as a group, which may increase the effective signal power at a receiving end of the group transmission. As another example, a node cluster may receive signals as a group, which may increase the effective signal power gathered by the receiving node cluster.

A factor in concerted operation of node clusters is the timing of the operation of each individual node in a node cluster. Precise timing coordination between the individual nodes in a node cluster may have several beneficial effects. For example, precise timing coordination may allow a cluster of nodes that are wirelessly connected to each other to transmit a signal simultaneously, or nearly simultaneously, and with coherent phases to a remote node or cluster of nodes. Such cooperation may increase an effective signal power produced at the receive end of the signal, which may allow for more communication range, more communication throughput, increased security, and/or other benefits.

As another example, precise timing coordination may allow a cluster of nodes that are wireless connected to each other to receive a signal simultaneously, or nearly simultaneously, and with coherent phases from a remote node or cluster of nodes. Such cooperation may increase an effective detected signal power received by the cluster of nodes, which may allow for increased range of detection, throughput received, increased security, and/or other benefits.

The benefits of precise timing coordination may be analogous to the beamforming gain achieved through transmitting and receiving signals using a dish or sector antenna or an analog or digitally controlled array of antenna. However, the precise timing coordination described herein may be utilized by disjointed devices, such a communication devices, connected wirelessly.

Described herein is a distributed wireless network containing one or more node clusters. Each node of a node cluster can transmit using precise timing coordination, enabling the nodes of a node cluster to transmit and receive signals simultaneously, or nearly simultaneously. The precise timing used by the nodes cluster may operate without using a universal time reference or a reference clock input (e.g., such as time references used in global positioning system (“GPS”) communication protocols) and may operate without timing signals communicated to and from a node cluster, such as timing signals sent from a base station or another node cluster.

In various non-limiting implementation described herein, a node cluster may establish precise timing coordination by each node of the node cluster establishing a timing grid and a relaxed timing grid. A timing grid may define times (referred to herein as “permitted times”) a node can perform certain actions. Some examples of actions that can be performed in accordance with a timing grid can include, but are not limited to, transmitting timing initialization signals, pilots, or other signals, signal monitoring for signals from other nodes in a node cluster, signal relay, calculating received signal time, estimating channel or other parameters and/or other estimating actions, calculating beamforming weights, synchronizing sensor data, detecting and/or localizing emitters, and emitting communication and/or noncommunication wireless signals, among others.

A relaxed timing grid may define times (referred to herein as “grid lines”) a node can perform other actions, such as relaying a transmitted signal. In some implementations, the timing grid and relaxed timing grid of a node may be related. For example, a grid line of a relaxed timing grid may occur after a set number of permitted times of the timing grid.

### A. Example Networking Device

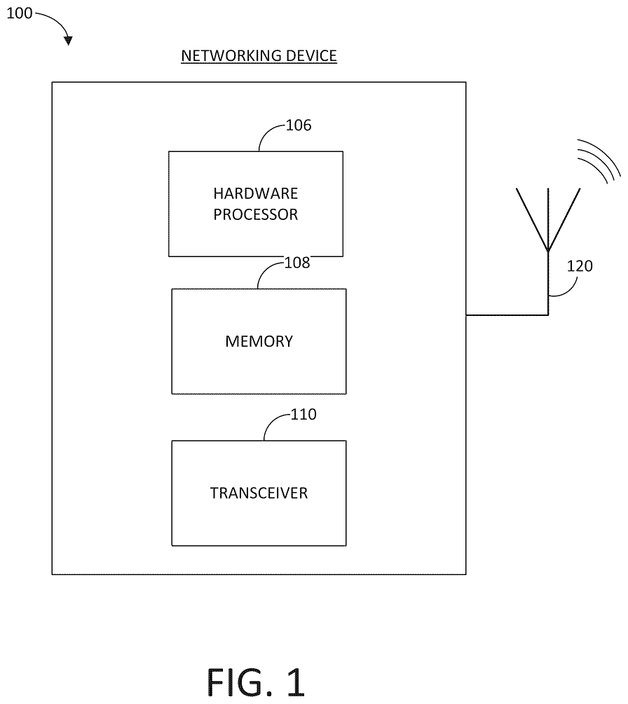

FIG. 1 illustrates an embodiment of a networking device 100 that may include a transceiver 110 and an antenna 120. The networking device 100 can form one of the nodes of a network and/or node cluster, such as discussed herein, including but not limited to a relay device, source device, destination device, reference device, nonreference device, and/or other device. In some embodiments, the networking device 100 can be a part of a network that includes a centralized hub. In some embodiment, the networking device 100 can be part of a mobile ad hoc network. The networking device 100 may include legacy radio devices. In some embodiments, the networking device 100 is a Rifleman Radio. In other embodiments, the networking device 100 is a radio that implements one or more of the Institute of Electrical and Electronics Engineers' (IEEE) 802.11 standards, such as, for example a “Wi-Fi” radio. A networking device 100 that implements one or more such IEEE 802.11 standards will be referred to herein as a radio, system, protocol, or technology that has “WiFi.” The networking device 100 can include a radio that uses Soldier Radio Waveform (SRW).

The networking device 100 includes a transceiver 110 for transmitting and/or receiving signals. In some embodiments, the networking device 100 can include more than one transceiver. For example, the networking device 100 may have separate transceivers for receiving and transmitting signals. In some embodiments, the networking device 100 can be a multiple-input multiple output (“MIMO”) networking device or other networking device.

The networking device 100 can include hardware and/or software modules. In the illustrated embodiment, the networking device 100 includes a hardware processor 106 and a memory 108. Further, in some embodiments, the memory 108 can include instructions corresponding to relay and communication. For example, the memory 108 can store commands for operation of the networking device 100, such commands may include commands to change its channel, sense interference, broadcast the interference matrix. The memory 108 can also store channel lookup matrix with the corresponding states of the respective channel. For instance, the memory 108 can store the detected interference in different channels for each of the nodes of the network. In some embodiments, the memory 108 can store information associated with a timing grid and/or relaxed timing grid, such as stored integers used to establish the timing grid and/or relaxed timing grid. The networking device 100 may also include additional modules not shown in the illustrated embodiment. For example, the networking device 100 may include a power source such as a battery.

### B. Example Node Cluster

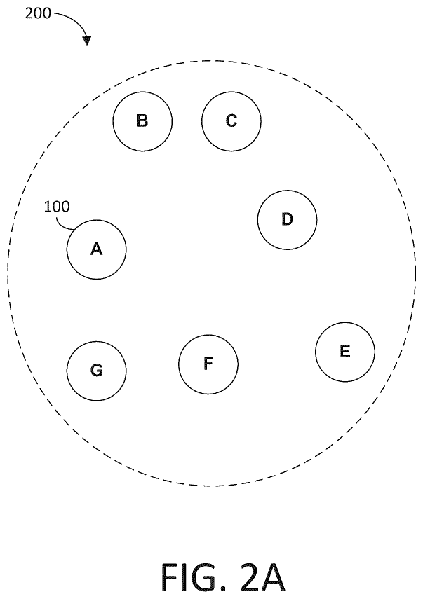

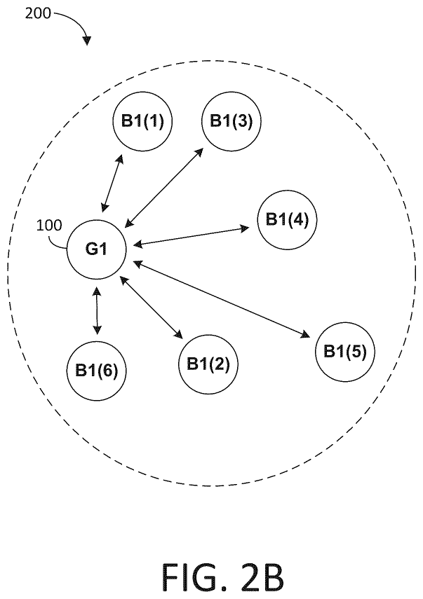

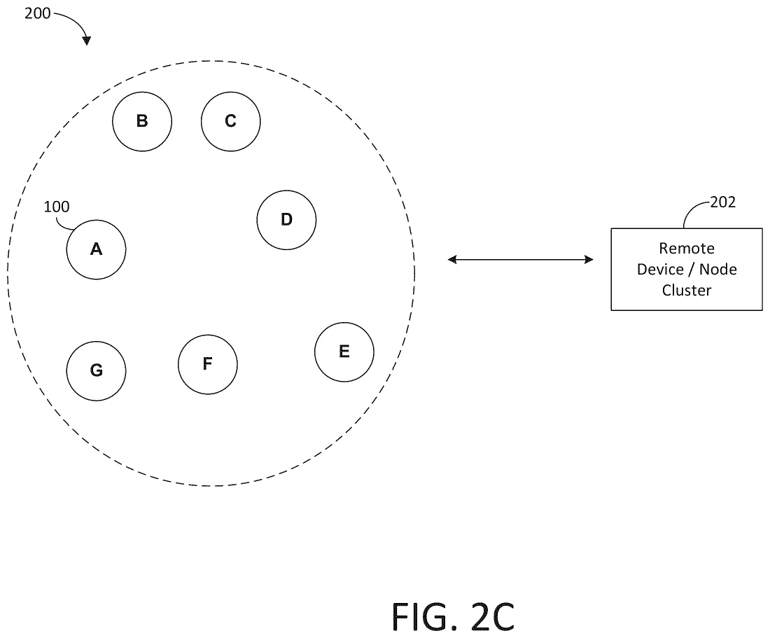

Example node clusters in a mobile network of networking devices 100 that may apply systems and methods described herein are shown in FIGS. 2A-2C, but it is understood that embodiments are not limited to the examples shown or described. In some embodiments, one or more methods, operations, or techniques may be performed by an element (such as a device, node, or other) of a mobile network. However, the scope of embodiments is not limited in this respect. Although a mobile network may be included in descriptions of some of the methods, operations, techniques, and concepts herein, the scope of embodiments is not limited in this respect.

Accordingly, one or more of the methods, operations, techniques, and concepts described herein may be used in embodiments, scenarios, and cases that may not necessarily include mobile networks or elements of mobile networks (like relay devices, source devices, destination devices, reference devices, nonreference devices, or other). In some embodiments, a device that may not necessarily be part of a network may perform one or more of the methods, operations, and/or techniques described herein. It is also understood that some embodiments may include additional devices than are shown in FIGS. 2A-2C.

FIG. 2A illustrates a node cluster 200 according to an embodiment. The node cluster 200 can contain a plurality of nodes (also referred to as tiles), such as nodes A-G. Each node of the node cluster 200, such as node A, may be a networking device 100 such as described in FIG. 1. However, the scope of the embodiment is not limited in this respect. For example, any of the nodes of node cluster 200 can be a different networking device, such as a base station, relay station, or other node in a network. Further, while FIG. 2A illustrates nodes A-G, the node cluster 200 may have more or fewer nodes.

Each of the nodes A-G of node cluster 200 may be in communication with each other. In certain instances, nodes A-G of node cluster 200 may be in communication with only subset of the other nodes or with only one other node of node cluster 200. For example, as depicted in FIG. 2B, when a node of node cluster 200 is designated as a reference node (also referred to as a reference tile, a gold node, or a gold tile), in some instances the nonreference nodes (also referred to as nonreference tiles, blue nodes, or blue tiles) of the node cluster 200 may only communicate with the reference node.

However, other communication configurations are also possible. For example, node cluster 200 may be split into two or more sub clusters. In this example, each node may communicate with other nodes in the same sub cluster, may communicate with nodes of another sub cluster, may communicate with a reference node of a sub cluster, or any other arrangement of communication.

In various implementations, each node of node cluster 200 may be in communication with one or more communication devices outside of node cluster 200. In some implementations, multiple nodes of the node cluster 200 may transmit the same transmission to one or more communication devices outside the node cluster 200 and/or may receive the same transmission from one or more communication devices outside the node cluster 200.

FIG. 2B illustrates the node cluster 200 arranged with reference node G1 according to an embodiment. As described above, a node of node cluster 200 may be designated as a reference node. A designation as a reference node may be predefined, based on hardware, based on transmission needs of a node and/or the node cluster 200, based on geographic factors, determined algorithmically, and/or otherwise determined. While reference node G1 is illustrated as a networking device 100, other transmission devices may be used. Further, FIG. 2B illustrates each nonreference node B1(1)-B1(6) as only communication with the reference node G1. It should be understood that other communication arrangements, such as the communication arrangements discussed in FIG. 2A may be used. For example, in some instances, nonreference node B1(1)-B1(6) may communicate directly.

As discussed above, in various implementations the nodes of node cluster 200 may coordinate signal transmission with devices outside of the node cluster 200. In some implementations, the reference node G1 generates a transmission signal and communicates the transmission signal to the nonreference nodes B1(1)-B1(6). In these implementations, the nonreference nodes B1(1)-B1(6) communicate the transmission signal received from the reference node G1 to one or more network devices outside of the node cluster 200. In these implementations, the reference node G1 may or may not also transmit the transmission signal to the one or more network devices outside of the node cluster 200 along with the nonreference nodes B1(1)-B1(6).

As discussed above, in various implementations the nodes of node cluster 200 may coordinate signal reception from devices outside of the node cluster 200. In some implementations, the nonreference nodes B1(1)-B1(6) receive a reception signal from one or more network devices outside of the node cluster 200. The reference node G1 may or may not also receive the reception signal from one or more network devices outside of the node cluster 200. The nonreference nodes B1(1)-B1(6) can communicate the reception signal to the reference node G1.

FIG. 2C illustrates an example of node cluster 200 communicating with a remote networking device and/or node cluster 202. The remote networking device and/or node cluster 202 may be a single transmission device or another node cluster like node cluster 200. While only one communication link connecting is illustrated in FIG. 2C between the node cluster 200 and the remote networking device and/or node cluster 202, it should be understood that multiple communication link can exist. In some implementations, each nonreference node of node cluster 200 establishes a communication link of each nonreference node of the remote networking device and/or node cluster 202. However, other communication arrangements may also occur. As discussed above, each node of node cluster 200 may communicate the same transmission and reception signals to and from the remote networking device and/or node cluster 202.

As discussed above, coordinated communication of the nodes of node cluster 200 may be beneficial. For example, coordinated signal transmission of the nodes of node cluster 200 can increase an effective signal power of a transmitted signal allowing for more range, throughput of transmission, and other transmission benefits. As another example, coordinated signal reception of the nodes of node cluster 200 can increase an effective signal power gathered by the node cluster 200 allowing for improved detection, rage of detection, quality of signal analysis, and other reception benefits.

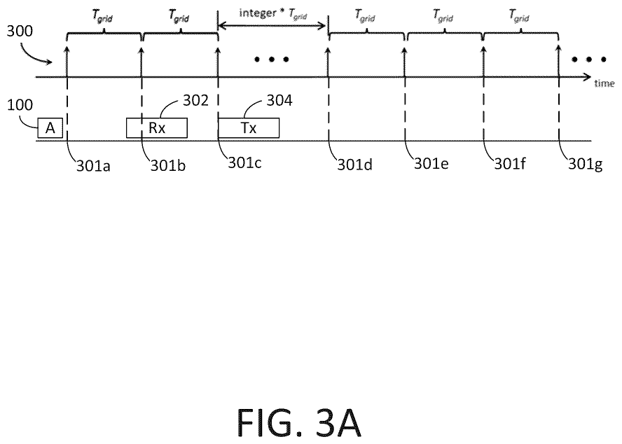

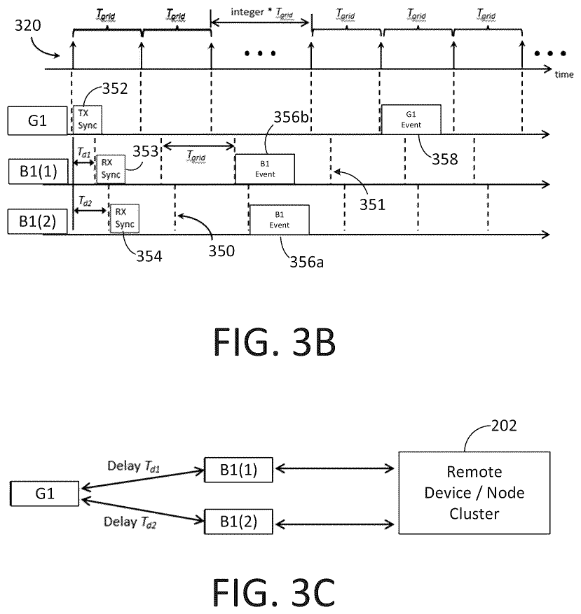

In order to effectively coordinate communication of the nodes the node cluster 200, each node transmits and/or performs other communication events, according to a timing grid and/or a relaxed timing grid. Timing grids and relaxed timing grids are discussed in more detail below with respect to FIGS. 3A-10.

### C. Examples of Timing Grids and Timing Grid Uses

FIG. 3A illustrates a timing grid 300 and uses thereof, according to non-limiting various implementations. A timing grid, as used herein, utilizes a set of permitted time slots 301a-301g (sometimes referred to herein as allowable times) that a communication device, such as a networking device 100, may perform certain actions, such as transmitting a signal. For convenience, the example of transmitting a signal may be used throughout this disclosure with reference to timing grids. However, it should be noted that other actions may also be performed in accordance with a timing grid. As previously described, some examples of actions that are performed in accordance with a timing grid can include, but are not limited to, transmission of timing initialization signals, pilots, or other signals, signal monitoring for signals from other nodes in a node cluster, signal relay, calculating received signal time, estimating parameters and/or other estimating actions, calculating beamforming weights, synchronizing sensor data, detecting and/or localizing emitters, and emitting communication and/or noncommunication wireless signals, among others.

Timing grid 300 may include permitted time slots, such a permitted time slots 301a-301g, that a communication device may perform actions, such as transmitting. In some examples, these permitted time slots can occur periodically. For example, timing grid 300 illustrates each permitted time slot 301a-301g as evenly distributed in time by a period of time, T_{grid}. However, permitted time slots 301a-301g may be non-periodic or selected based on any number of considerations associated with the network or networking device. In various implementations, the period of a timing grid (the value of T_{grid}) is defined by an operating frequency. For example, in one implementation the period of a timing grid may be:

$${T}_{g r i d} = k * \frac{1}{f}$$

In this example, k may be a predefined or determined integer value and f may be any operating frequency for communication devices. In some implementations, k and/or f can be communicated to other communication devices to facilitate synchronization of timing grides between the communication devices. Further, in some implementations, the period of a timing grid can be determined based on factors other than described in the above example or the period of a timing grid can be predetermined.

In various implementations, the period of a timing grid may be based on and/or determined in part on the geometry of a cluster of nodes a networking device 100 operates in. In various implementations, the period of a timing grid may be based on and/or determined in part on geographic and/or other communication condition considerations of a cluster of nodes a networking device 100 operates in, such as the distance between the nodes of the cluster. For example, when nodes of a cluster are distanced farther apart or operate in a noisy environment, the period of the timing grid may increase to compensate. In some implementations, the value of k can be selected and/or determined to accommodate such conditions.

In some implementations, timing grid 300 may have a set number of permitted time slots 301. The number of permitted time slots 301 of the timing grid 300 may be defined. For example, timing grid 300 is illustrated in FIG. 3A as having seven permitted time slots 301a-301g, plus an integer number of permitted time slots 301. In this case, the integer may be determined by an operating frequency, predefined in hardware, defined when timing grid 300 was initialized, and/or determined another way. The permitted time slots 301 in a timing grid may also be indefinite. For example, a timing grid can have a permitted time slots 301 every period until an occurrence, such as a signal designating a new period length or that a new period length should be established.

Not every event a communication device undergoes will fall in accordance with the communication devices timing grid. For instance, a communication device may receive a transmission signal at a time other than a permitted time slot. Illustrating this point, in FIG. 3A a reception event 302 is received by the networking device 100 at a time starting before a permitted time slot of timing grid 300. A signal reception at non permitted times can be common, especially in a node cluster where each node has an individual timing grid and/or where each node has variable geographic factors effecting signal time. However, actions a communication device perform in response can fall on a permitted slot regardless of when a reception signal was received. For example, transmission event 304 occurs on permitted time slot 301c even though reception event 302 did not.

In some implementations, when a communication device 100 detects a received signal, such as the reception event 302, the communication device 100 may perform some actions, such as estimating parameters and/or other estimating actions, or other actions at a permitted time slot that intersects the received signal. Estimating actions, can include, but are not limited to timing estimations (e.g., estimating a time of arrival and/or other timing estimation), channel estimations, phase estimation (e.g., estimating a phase of arrival and/or other phase estimation), or any other estimation. For example, networking device 100 may perform an estimating action at permitted time slot 301b. The networking device 100 may perform these actions even if the rest of the received signal has yet to be received. For instance, the networking device 100 may perform these actions at permitted time slot 301b concurrently with receiving the rest of reception event 302.

FIGS. 3B and 3C illustrate the use of timing grids to coordinate communication in a node cluster. FIGS. 3B and 3C illustrate an implementation of timing grids with a designated reference node G1 and other nodes B1(1) and B1(2). However, the principles described with respect to FIGS. 3B and 3C may be utilized in node clusters or other communication systems without a designated reference node.

As illustrated in FIG. 3B reference node G1 establishes timing grid 320. Timing grid 320 may include all the features of timing grid 300 described in FIG. 3A. Nodes B1(1) and B1(2) each operate on individual timing grids. For example, node B1(1) operates on timing grid 351 node B1(2) operates on timing grid 350. However, the period of each timing grid (the value of T_{grid}) is the same, or substantially the same for the timing grid of each node.

In various implementations, the reference node G1 establishes the period of timing grid 320. As described above, in some implementations reference node G1 can establish the period of timing grid 320 using an operating frequency of the reference node G1. After establishing the period of timing grid 320, the reference node transmits a timing initialization (such as a synchronization (“sync”) packet) signal 352 to nodes B1(1) and B1(2). As illustrated in FIGS. 3B and 3C, the timing initialization signal 352 is not instantaneously received by nodes. For example, node B1(1) receives the timing initialization signal 353 after a time delay, T_{d1} and node B1(2) receives the timing initialization signal 354 after a time delay, T_{d2}.

In various implementation, reference node G1, node B1(1), and node B1(2) are unaware of the time delay of each node. For example, T_{d1} and T_{d2} may not be tracked by nodes. Further, reference node G1 may not record a timestamp when timing initialization signal 352 was sent to nodes B1(1) and B1(2). As such, each node may only operate with knowledge of the node's own timing grid.

After receiving a timing initialization signal, such as timing initialization signal 354, the nodes B1(1) and B1(2) each establish timing grids starting at the time the timing initialization signal was received. For example, receiving the timing initialization signal may flag a time to begin each timing grid. As such the timing grids of nodes B1(1) and B1(2) each have an offset defined by the respective time delays. Each of the nodes B1(1) and B1(2) establishes individual timing grids. For instance, node B1(1) establishes timing grid 351 and node B1(2) establishes timing grid 350. In various implementations, to establish the individual timing grids, nodes B1(1) and B1(2) perform frequency synchronization with reference node G1 to determine and/or estimate the operating frequency of reference node G1. Nodes B1(1) and B1(2) can then establish timing grid 351 and timing grid 350, respectively using the determined and/or estimated frequency. In various implementations, the operating frequency of the reference node G1 may be determined and/or estimated in other ways, such as by a transmission of carrier frequency pilots, a hardware setting, a retrieval from memory, and/or other technique.

Each individual node of a node cluster performs operations according to the timing grid of the individual node. As illustrated in FIG. 3B, node B1(1) performs B1 event 356b according to timing grid 351 and node B1(2) performs B1 event 356a according to timing grind 350. In some implementations, B1 event 356a and B1 event 356b can be the same event or a related event. For example, B1 event 356a and B1 event 356b may be a transmission of the same transmit signal. In these implementations, the transmission of B1 event 356a and the transmission of B1 event 356b are occurring at different times and will likely be received at different times. For example, B1 event 356a and B1 event 356b may be a transmission of a signal to reference node G1 which will likely receive the two signals at different times. Some examples of B1 event 356a and B1 event 356b can include transmitting timing initialization signals, pilots, and the like to the reference node G1, monitoring for signals form the reference node G1, channel estimation for links between the node and the reference node G1 (e.g., node B1(1) and reference node G1), channel estimation for links between nonreference nodes (e.g., node B1(1) and node B1(2)), transmitting timing initialization signals, pilots, and the like to other clusters, monitoring for signals from other clusters, receiving packets/signals from the reference node G1, relaying packets/signals from the reference node G1 to other clusters, and relaying packets/signals from the another cluster to the reference node G1, to list a few. As another example, B1 event 356a and B1 event 356b may noncommunication events such as emitting a signal towards a common destination, calculating beamforming parameters, performing estimation actions, or any other noncommunication actions.

Similarly, FIG. 3B illustrates reference node G1 performing G1 event 358 according to timing grid 320. Some examples of G1 event 358 can include transmitting timing initialization signals, pilots, and the like, monitoring for signals from other nodes of a cluster, and channel estimation for links between the reference node and other nodes of the cluster, to list a few.

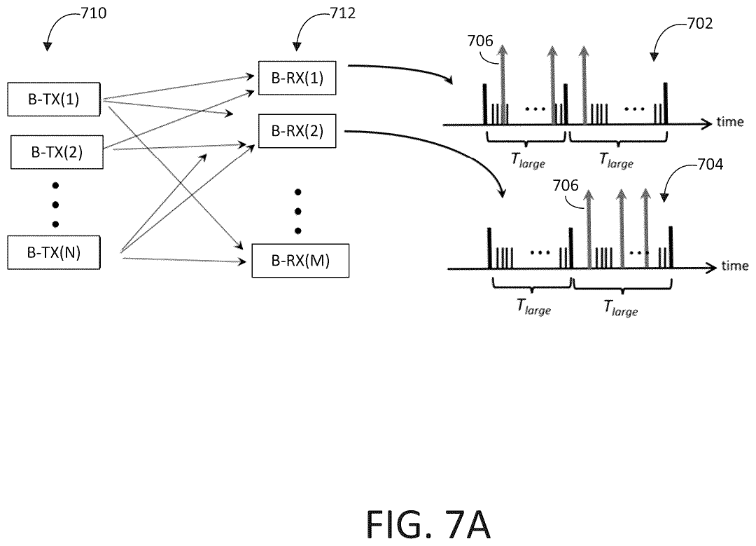

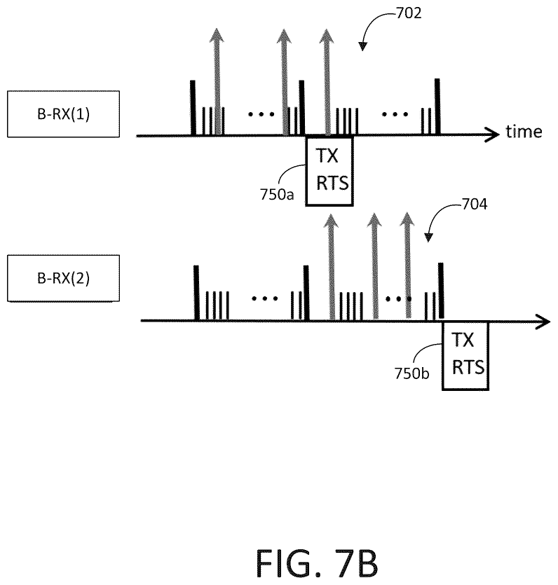

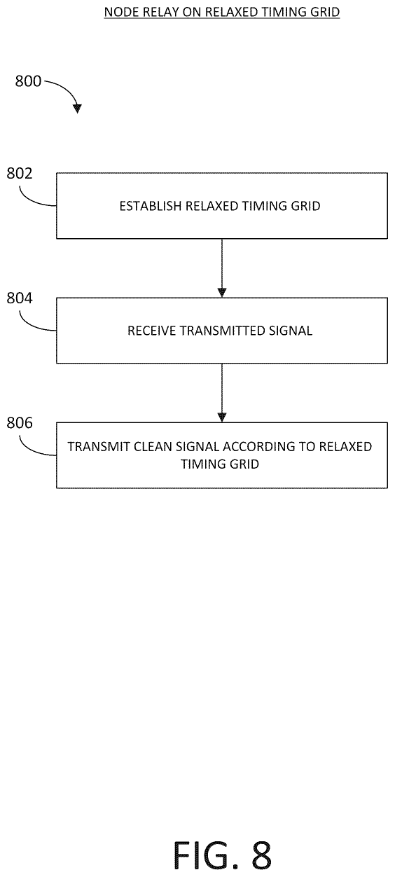

Referring to FIG. 3C, in some implementations, nodes B1(1) and B1(2) may act as a relay devices from the reference node G1 to one or more devices outside the node cluster, such the remote device and/or node cluster 202 of FIG. 2C. In these implementations, nodes B1(1) and B1(2) may received the same transmission signal from reference node G1 but at different times, due to differing delays. As such, in some implementations, nodes B1(1) and B1(2) may relay the transmission signal and/or transmit a fresh transmission to the remote device and/or node cluster 202 at offset times. The receipt and processing of offset transmissions is discussed in more detail with reference to FIGS. 7A, 7B, and 8. In some implementations, nodes B1(1) and B1(2) may transmit a pre-recorded signal for communication, propagation of an emission signal, and/or other effect based on the transmission signal.

### D. Example Process for Establishing Reference Node Timing Grid

In some embodiments, one or more of the following may be performed at one of the devices described herein. It is noted that the devices may not necessarily perform all of the operations below, in some embodiments.

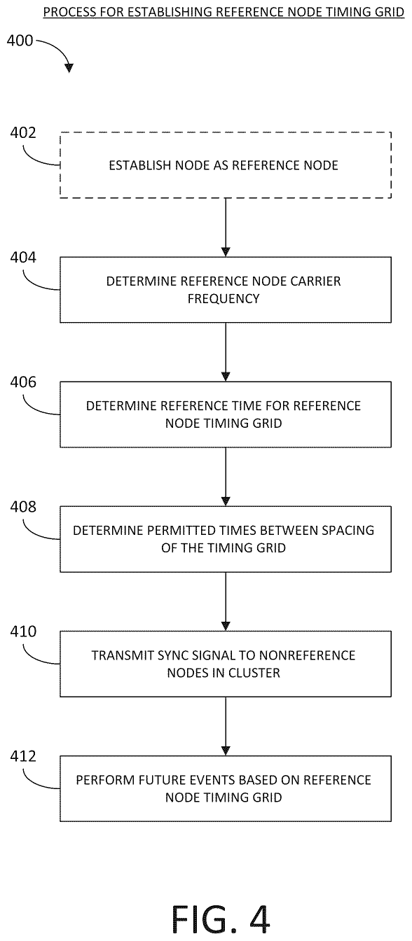

FIG. 4 illustrates a process 400 for establishing a reference node timing grid, such as timing grid 320. Process 400 can be performed by a node of a node cluster, such as by networking device 100. Some of the operations may be omitted or performed in a different order. In some implementations, a network cluster may not perform process 400 at all or may only perform part of process 400. For example, where a network cluster may not utilize a reference node and establish a reference timing grid in a different way, such as based on a prior information know to networking devices and/or may not establish a reference timing grid to establish node specific timing grids.

At optional block 402, the node is established as a reference node. In some implementations, block 402 does not occur. For example, the node cluster may not have a reference node, or the reference node may be predetermined. In some implementations, a node is established as a reference node based on a hardware setting. In some implementations, a node is established as a reference node based on a transmission event, for example if a node needs to transmit or receive a signal from a distant device or node cluster. However, these implementations are not limiting and a node may be established as a reference node in other ways.

At block 404, the reference node determines an operating frequency. The node may implement a phase lock loop (“PLL”), perform operating frequency synchronization, may read a value from memory, may receive a setting from hardware, and/or may determine an operating frequency using another technique. At block 406, the reference node determines a reference time for reference node timing grid. In some implementations, the reference time is a time in which the PLL of the node passes through a zero phase. However, other techniques can be used, such as a reading a value from memory or a hardware setting, to name a couple.

At block 408, the reference node determines permitted time between spacing of the timing grid (also referred herein a the period of the timing grid or T_{grid}). In some implementations, the permitted time between spacing of the timing grid is a function of the operating frequency determined at block 404. For example, in some implementations the permitted time between spacing of the timing grid using the following:

$${T}_{g r i d , G} = k * \frac{1}{{f}_{G}}$$

In the equation above T_{grid,G} represents the permitted time between spacing of the timing grid for the reference node and f_{G} is the operating frequency of the reference node. As previously indicated, integer k may be predefined or may be determined. The timing grid can have permitted times for action to occur at intervals defined by the reference time determined at block 406 and the period of the timing grid. For example, a timing grid can have a permitted time for action to occur beginning a the reference time and reoccurring each period of the timing grid.

At block 410, the reference node transmits a timing initialization signal to other nodes in a node cluster. The timing initialization signal can be timing initialization signal 352 of FIG. 3B. The timing initialization signal can indicate the reference time for the timing grid of the reference node. In some implementations, the timing initialization signal can include additional information, such as information used to derive operating frequency, integer values used to calculate timing grids, and/or other information.

At block 412, the reference node performs future events based on reference timing grid. For example, the reference node can transmit pilots and the like, monitor for signals from other nodes of a cluster, and perform channel estimation for links between the reference node and other nodes of the cluster, to list a few.

FIG. 4 illustrates a process 500 for establishing a timing grid for a node other than a reference node, such as timing grid 350 or timing grid 351. Process 500 can be performed by a node of a node cluster, such as by networking device 100. Some of the operations may be omitted or performed in a different order.

At block 502, the nonreference node determines the an operating frequency. As previously described a nonreference node can perform operating frequency synchronization with a reference node to determine and/or estimate the operating frequency of the reference node. This determined or estimated operating frequency can be used as the operating frequency of the nonreference node. In some implementations other techniques are used to determine the operating frequency such as a hardware setting, a stored value in memory, a transmission from the reference node or other communication device, or other technique.

At block 504, the nonreference node receives a timing initialization signal from the reference node. The timing initialization signal can establish a reference time for a timing grid of the nonreference node. For example, the timing initialization signal may flag a time for the timing grid of the nonreference node to begin. The timing initialization signal can be the same signal transmitted at block 410 of FIG. 4. However, as described above, the nonreference node will not instantaneously receive the timing initialization signal when the reference node transmits the timing initialization signal. As such, a time delay can exist between the reference time of the reference node and the reference time of the nonreference node.

At block 506, the nonreference node determines permitted times between spacing of the timing grid. (also referred herein a the period of the timing grid or T_{grid}). In some implementations, the permitted time between spacing of the timing grid is a function of the operating frequency determined at block 502. For example, in some implementations the permitted time between spacing of the timing grid using the following:

$${T}_{g r i d , B} = k * \frac{1}{{f}_{B}}$$

In the equation above T_{grid,B} represents the permitted time between spacing of the timing grid for the nonreference node and f_{B} is the operating frequency of the nonreference node. As previously indicated, integer k may be predefined or may be determined. The timing grid can have permitted times for action to occur at intervals defined by the reference time determined by the timing initialization signal at block 504 and the period of the timing grid. For example, a timing grid can have a permitted time for action to occur beginning a the reference time and reoccurring each period of the timing grid.

At block 508, the nonreference node performs future events based on reference timing grid. For example, the nonreference node can transmit pilots and the like, monitor for signals from other nodes of a cluster, and perform channel estimation for links between the reference node and other nodes of the cluster, to list a few. Some examples events the nonreference node can perform can include transmitting timing initialization signals, pilots, and the like to the reference node, monitoring for signals form the reference node, channel estimation for links between the node and the reference node G1, channel estimation for links between the nonreference node and other nonreference nodes, transmitting timing initialization signals, pilots, and the like to other clusters, monitoring for signals from other clusters, receiving packets/signals from the reference node, relaying packets/signals from the reference node to other clusters, and relaying packets/signals from the another cluster to the reference node, to list a few.

### E. Examples of Relaxed Timing Grids and Relaxed Timing Grid Uses

In various implementations, a relaxed timing grid may be utilized to facilitate aspects of reception and transmission of internode communication. A relaxed timing grid, as used herein, may define allowable times (referred to herein as “grid lines”) for certain operations in signal transmission and reception and signal processing. A relaxed timing grid may be related to a timing grid. For instance, a relaxed timing grid of a node may define a grid line to occur every time a set number of permitted times occur in the timing grid of the same node.

A challenge when coordinating transmission and reception of multiple nodes with individually defined timing grids within a cluster is timing signal processing and communication algorithms. For instance, a receiving node may receive packet for handshake protocol initialization, such as a request to send (“RTS”) packet, from a transmitting cluster of nodes. Each of the transmitting cluster of nodes is operating on a timing grid with different time offsets. Further each of the transmitting nodes may have geographic factors that contribute to differing delays of the RTS packet received from each of the transmitting nodes. As a result, the receiving node may receive the RTS packet from one transmitting node timing grid periods receiving a the RTS packet from a different transmitting node. As such, it can be unclear when the receiving node should relay the RTS packet and/or transmit a packet to complete the handshake protocol, such as a clear to send (“CTS”) packet. For example, the receiving node may not know how many nodes are in the transmitting cluster of nodes and thus, at any point after receiving a first RTS packet could receive one or more additional RTS packets. In various implementations, the relaxed timing grid disclosed herein address the challenge of timing signal processing and communication algorithms by providing timing structures and algorithms capable of handling large variance in the timing of signal reception and/or signal transmission.

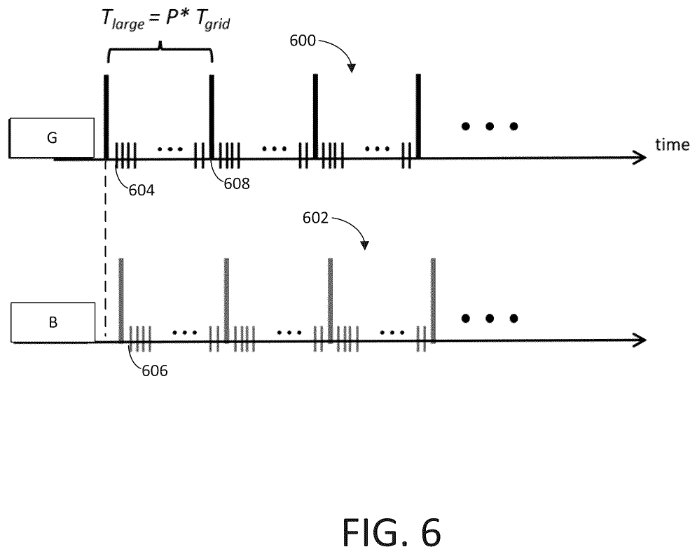

FIG. 6 illustrates a relaxed timing grid 600 for a reference node G and a relaxed timing grid 602 for another node B. Node B may be a nonreference node in the same cluster as reference node G or another node outside of the cluster. Each small line marker depicted in FIG. 6, such as line marker 604 and line marker 606 represent a permitted time as defined by the timing grid of the node. Each large line marker, represent grid lines, such as grid line 608, for the relaxed timing grid. As illustrated in FIG. 6, a grid line of the relaxed timing grid occurs every for every P permitted times of the timing grid, where P is an integer value. While FIG. 6 illustrates six or more permitted times between each grid line of a relaxed timing grid, fewer permitted times may occur between each grid line of the relaxed timing grid. Indeed, the number of permitted times in a grid line period of a relaxed timing grid may vary according to the communication environment the relaxed timing grid is operating in.

As illustrated in FIG. 6 the relaxed timing grids of separate nodes can be misaligned, such that the defined grid lines may occur at different moments in time. This misalignment may be cause by similar factors as the misalignment of the timing grid, for example, due to time delays to transmit a timing initialization signal. In various embodiments, the relaxed timing grid of a node is defined concurrently with the timing grid of the node. For example, when a reference node determines a reference time or when node receives a timing initialization signal from a reference node. The number of timing grid periods that defines the relaxed timing grid (e.g., integer P) may be predefined, retrieved from memory, set by and/or received by a reference node, determined by hardware, or determined another way.

In various implementations, the time between grid lines may be based on and/or determined by the communication environment. For example, the value of P may be set, such that no more than two grid lines may occur before the node will receive all coordinated transmissions from another node cluster.

FIGS. 7A and 7B illustrate the use of a relaxed timing grid to relay a signal from a transmission node cluster 710 through a reception node cluster 712. Each node of the reception node cluster 712 receives a transmission signal 706 from each node of the transmission node cluster. As such, each node of the reception cluster 712 receives N copies of the transmission signal, where N is equal to number of nodes in the transmission node cluster 710. However, node B-RX(1) of reception node cluster 712 receives the first transmission signal 706 (as shown on relaxed timing grid 702) at an earlier time than node B-RX(2) of reception node cluster 712 receives the first transmission signal 706 (as shown on relaxed timing grid 704). As previously described, the time difference in receiving the first transmission signal 706 can be caused by differences in timing grids, geographical factors, or other factors.

Without the use of a relaxed timing grid, the time difference in receiving the first transmission signal 706 can be problematic when a node relays the transmission signal. The impulse responses of the transmission signals 706 may not be like typical wireless impulse responses. For example, the impulse responses may not have channel-induced delay spread, in which the power level generally decreases with time spacing (for example, in a two-ray model, the earlier ray is typically modeled as much stronger than the later ray). Instead, each ray in the impulse responses at the reception node cluster 712 nodes may have a significant power level. In some implementations, the impulses may have a significant power level due to the same impulse being transmitted to the reception node cluster 712 from the multiple nodes of the transmission node cluster 710, which may result in a less decaying impulse than would be received from a single node.

In implementation where the impulse responses of the transmission signals 706 are not like typical wireless impulse responses, it may be unclear which time instant of the impulse response should be detected by a packet detection algorithm (e.g., should the algorithm use the earliest ray, strongest ray, a “centroid” type of measurement, and so on). Further again, because each impulse response may be widely spread, and the impulse responses at node cluster 712 nodes are different, the subsequent relay of the received aggregate signals may be messy. For instance, the node that receives the relayed signal may have a similar issue, attempting to detect a packet characterized by a very largely spread composite impulse response.

FIG. 7B illustrates how reception node cluster 712 can utilize a relaxed timing grid to relay a transmission packet, such as an RTS packet or other packetized handshake protocol initializing packet, transmitted to the reception node cluster 712 from the transmission node cluster 710. In some implementations, each node of the reception node cluster 712 will transmit an transmission packet according to the next available grid line defined by the node's relaxed timing grid after receiving an impulse. The grid line used can be defined by the earliest impulse received. For example, node B-RX(1) transmits RTS packet 750a at the next available grid line, even though node B-RX(1) receives another impulse after RTS packet 750a (regardless of whether node B-RX(1) is aware that further impulses are to be received).

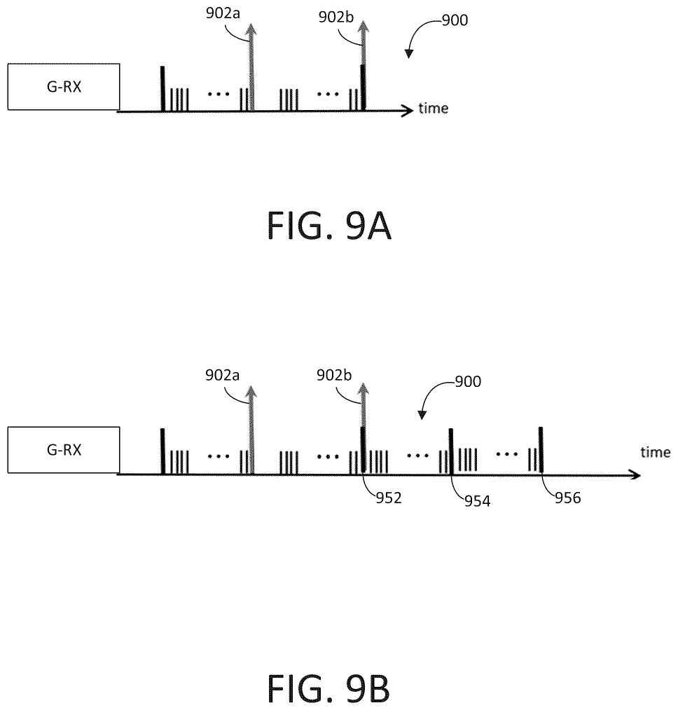

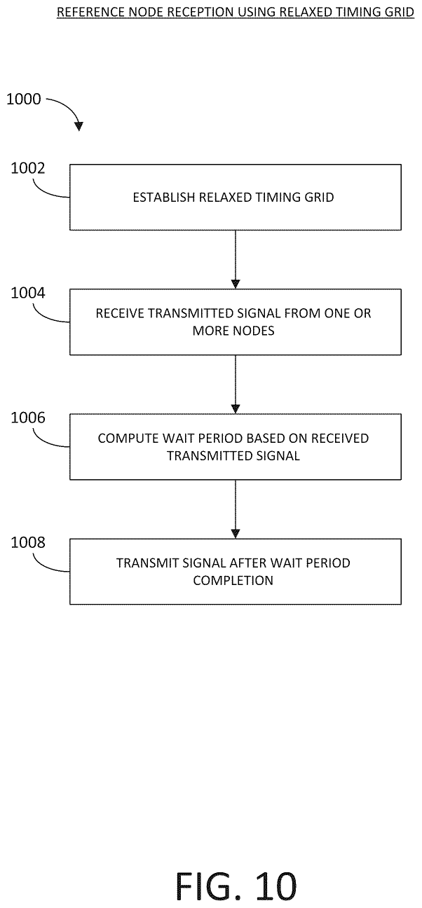

The relaxed timing grid does not guarantee that each node will relay the transmission packet on the same grid line cycle. For example, node B-RX(2) transmits transmission packet 750b one cycle later on relaxed timing grid 704 than node B-RX(1) transmits transmission packet 750a on relaxed timing grid 702. In some instances, different nodes may transmit more than one cycle offset on a relaxed timing grid. For example, there may be a great geographic distance between the nodes or other significant environmental factors. However, in some implementations, the length of time between grid lines is set such that only one grid line may occur between received transmission packets. How a receiving node can handle offsets will be described in more detail with reference to FIGS. 9A, 9B, and 10.

In some implementations, transmission packet 750a and transmission packet 750b can be a fresh or newly generated transmission packet from reception node cluster 712, instead of relaying aggregated signal. By transmitting a clean transmission packet the reception node cluster 712 can remove a difficult impulse response and avoid relaying the noise and interference, among other benefits. Further, in some implementations, the reception node cluster 712 can perform rough timing detection of the transmission packet from the transmission node cluster 710, reducing a need for precise timing detection of a very widely spread aggregate transmission signal from the transmission node cluster 710.

In some implementations, after the an initial handshake protocol the reception node cluster may transition from transmitting a fresh transmission packet based on a received transmission packet to relaying a received transmission packet. For example, after node B-RX(1) and node B-RX(2) have transmitted a fresh RTS transmission packet (or other transmission packet) to another node and received a CTS transmission (or other transmission packet confirming a handshake protocol), node B-RX(1) and node B-RX(2) may relay received transmission packets rather than generating new ones.

### F. Example Process for Relaying Signal on Relaxed Timing Grid

In some embodiments, one or more of the following may be performed at one of the devices described herein. It is noted that the devices may not necessarily perform all of the operations below, in some embodiments.

FIG. 8 illustrates a process 800 for relaying a signal on a relaxed timing grid, such as relaxed timing grid 602. Process 800 can be performed by a node of a node cluster, such as by networking device 100. Some of the operations may be omitted or performed in a different order.

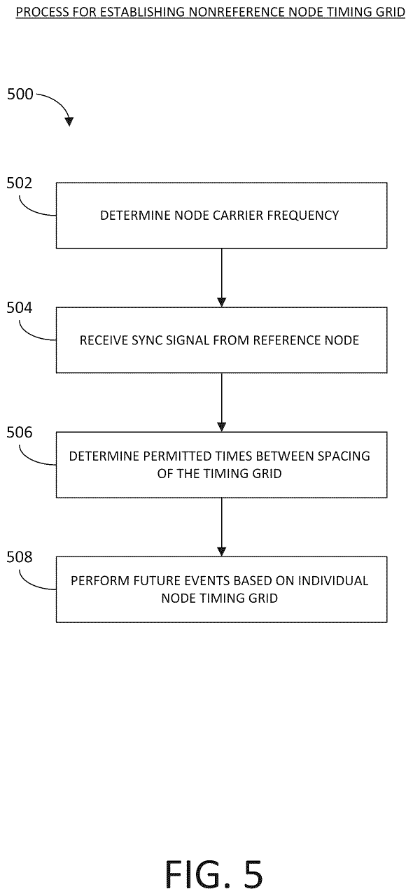

At block 802, the node establishes a relaxed timing grid. In various embodiments, the relaxed timing grid is defined concurrently with the timing grid of the node. For example, block 802 may happen concurrently or following process 500 of FIG. 5. The node may use an integer number (e.g., integer P) of timing grid periods (the value of T_{grid}) to define the relaxed timing grid. The integer number (e.g., integer P) of the relaxed timing grid may be predefined, retrieved from memory, set by and/or received by a reference node, determined by hardware, or determined another way.

At block 804, the node receives a transmitted signal. For example, the node can receive an impulse such as transmission signal 706 associated with a RTS packet (or other transmission signal) from a node cluster such as transmission node cluster 710. Upon receiving the transmitted signal, the node may process the transmitted signal. For example, the node can perform rough timing detection of a RTS packet, reducing a need for precise timing detection of a very widely spread aggregate RTS signal from a transmission node cluster.

As described above the impulse responses of the transmitted signal may not be like typical wireless impulse responses. For example, the impulse responses may not have channel-induced delay spread, in which the power level generally decreases with time spacing (for example, in a two-ray model, the earlier ray is typically modeled as much stronger than the later ray). Instead, each ray in the impulse responses at the node may have a significant power level.

At block 806, the node transmits a clean signal according to the relaxed timing grid. As described above, a clean signal can be a fresh or newly generated RTS packet. However, the transmitted signal may be another signal. In some implementation, the node is transmitting this clean signal instead of relaying an aggregated signal. By transmitting a clean RTS packet the reception node can remove difficult impulse responses and avoid relaying noise and interference, among other benefits. The clean signal may be transmitted on the next available grid line as defined by the earliest received transmitted signal. In some instances, at block 804, the node may receive multiple transmitted signals. In these instances, the node will transmit the clean signal at the next relaxed event from the transmitted signal that was received first. In some implementations, the transmitted signal may be a clean RTS packet transmitted a reference node of a node cluster.

### G. Examples of Uses of a Relaxed Timing Grid by a Reference Node

FIGS. 9A and 9B illustrate the use of a relaxed timing grid 900 for a reference node G-RX to receive signals from other nodes of a node cluster and determine a time to transmit. For purposes of illustration, the example use of RTS packets reception and responding CTS packet transmission by the reference node G-RX will be described. However, other transmission signals used in handshake protocols may also be used. As described with reference to FIG. 7B, RTS packets from multiple nodes may be transmitted to the reference node G-RX. Further, each RTS packet may fall on different grid lines of the relaxed timing grid. This may occur from natural spreading of impulse response transmission due to environmental or other factors.

As a result, the reference node G-RX may detect groups of RTS packets from the other nodes of a node cluster at multiple instances in time. FIGS. 9A and 9B illustrate the reference node receiving a first group of RTS packets 902a at a first grid line and a second group of RTS packets 902b at a second grid line. In some implementations, more than two groups of RTS packets may be received by the reference node. For example, in some situations, delay in receiving a signal at a node may cause the node to transmit an RTS packet to the reference node G-RX at a third grid line. Since the reference node G-RX may receive RTS packets from the nodes in the node cluster at different grid lines, it can be ambiguous when the reference node G-RX should send a CTS packet.

In some implementations, the reference node G-RX can handle the ambiguity for reception of the RTS packets by first continuously attempt to detect RTS packets from the other nodes of a node cluster. Next, when a first set of RTS packet are detected, the reference node G-RX can assume that the detected set of RTS packet is the first/earliest set of RTS packet. Then, the reference node G-RX can compute a wait period for transmission of the CTS packet based on the assumption that the detected set of RTS packet is the first set of RTS packet, and a second set of RTS packet may arrive.

The result is a comfortable margin (which is known by both the reference node G-RX and the other nodes of the node cluster) at which the CTS packet will be transmitted by the reference node G-RX. This helps to avoid potential conflict scenarios. For example, if the reference node G-RX immediately responds with a CTS after detecting an RTS packet, then the reference node G-RX may be transmitting the CTS while one of the nodes of the node cluster is still transmitting an RTS packet.

FIG. 9B illustrates how such a margin may be used. The reference node G-RX receives a first group of RTS packets 902a. However, at the next available grid line to transmit a CTS packet (grid line 952), the reference node G-RX assumes that another set of RTS packets may be received and thus, does not transmit the CTS packet. It should be noted, that while FIG. 9B illustrates this assumption is correct (e.g., the second group of RTS packets 902b is received at grid line 952), reference node G-RX does not transmit the CTS packet at grid line 952 based on the assumption of a potential RTS packet rather than the reality of a received RTS packet. As such, even without receiving second group of RTS packets 902b at grid line 952, reference node G-RX will not transmit a CTS packet at grid line 952.

FIG. 9B illustrates two potential grid lines a CTS packet may be transmitted. The CTS packet may be transmitted at grid line 954 or at grid line 956. The use of grid line 954 or grid line 956 for transmitting the CTS packet may depend on balancing factors. For example, grid line 956 may be more desirable in communication environments where reference node G-RX operates in a node cluster with large distances between some nodes of the node cluster, in instances where P of the relaxed timing grid is small, or in other circumstances. As another example, grid line 954 may be more desirable where a fast response of a CTS packet and/or other transmission signals is preferred.

### H. Example Process of Reference Node Reception Using a Relaxed Timing Grid

In some embodiments, one or more of the following may be performed at one of the devices described herein. It is noted that the devices may not necessarily perform all of the operations below, in some embodiments.

FIG. 10 illustrates a process 1000 for a reference node to process a transmitted signal. Process 1000 can be performed by a node of a node cluster, such as by networking device 100. Some of the operations may be omitted or performed in a different order.

At block 1002, the reference node establishes a relaxed timing grid. In various embodiments, the relaxed timing grid is defined concurrently with the timing grid of the node. For example, block 1002 may happen concurrently or following process 400 of FIG. 4. The node may use an integer number (e.g., integer P) of timing grid periods (the value of T_{grid}) to define the relaxed timing grid. The integer number (e.g., integer P) of the relaxed timing grid may be predefined, retrieved from memory, determined by hardware, or determined another way.

At block 1004, the reference node receives a transmitted signal from one or more nodes, such as other nodes of a node cluster. For example, the reference node can receive a set of RTS packets, or other transmission packets, from other nodes of the node cluster. In some implementations, the reference node continuously attempt to detect transmitted signals from the other nodes of a node cluster. Further, in some implementations, when the reference node receives the transmitted signal assumes the transmitted signal was the first transmitted signal and that at least one more transmitted signal may be received.

At block 1006, the reference node computes a wait period based on the received transmitted signal. As described above, in various implementations the wait period may be one grid line period or two grid line periods. As such, the reference node can avoid a transmission conflict with another node of the node cluster.

At block 1008, the reference node transmits a signal after the wait period has completed. For example, the reference node can transmit a CTS packet, or another transmission packet, to the other nodes of the node cluster after the wait period (e.g., on grid line 954 or grid line 956).

### I. Additional Examples

Disclosed herein are additional examples of systems and methods described herein. Any of the examples in this disclosure may be combined in whole or in part.

Example 1: A system for synchronizing transmission between nodes of distributed network, the system comprising: a first node of a plurality of nodes in a communication network, the first node comprising: a memory; an antenna; a transceiver; and one or more hardware processors configured to: receive a timing initialization signal from a second node of the plurality of nodes; determine an operating frequency; determine a timing grid based at least in part on the timing initialization signal, wherein the timing grid comprises permitted times the first node can perform an action; and perform the action at a permitted time of the timing grid.

Example 2: The system of Example 1, wherein to determine the operating frequency, the one or more hardware processors are configured to perform operating frequency synchronization with the second node.

Example 3: The system of any of Examples 1-2, wherein the one or more hardware processors are further configured to receive a request to send (“RTS”) packet from the second node.

Example 4: The system of Example 3, wherein the action comprises transmitting the RTS packet to a third node of the plurality of nodes.

Example 5: The system of any of Examples 1-4, wherein the action comprises transmission of a first signal to another node or cluster of nodes in the communication network.

Example 6: The system of Example 5, wherein the first signal is received by the first node during a non-permitted time of the timing grid.

Example 7: The system of Example 5, wherein the first signal is relayed by the first node from a stored location.

Example 8: The system any of Examples 1-7, wherein the operating frequency is a common operating frequency between the plurality of nodes in the communication network.

Example 9: The system any of Examples 1-8, wherein the timing initialization signal comprises a flag to begin the timing grid.

Example 10: The system of any of Examples 1-9, wherein a periodicity between permitted times of the timing grid is based on at least a geographic or communication distance between at least some of the plurality of nodes.

Example 11: The system of Example 10, wherein an earliest in time permitted time of the timing grid occurs after a first period of the periodicity.

Example 12: A system for synchronizing transmission between nodes of distributed network, the system comprising: a first node of a plurality of nodes in a communication network, the first node operating on a first timing grid, wherein the first timing grid comprise one or more permitted times the first node can perform one or more actions; and a second node of the plurality of nodes operating on a second timing grid, wherein the second timing grid comprises one or more permitted times the second node can perform the one or more actions; wherein each of the first timing grid and the second timing grid have a shared periodicity between their respective permitted times; wherein the first node is configured to transmit a signal at a first permitted time of the first timing grid to at least the second node of the plurality of nodes; and wherein the second node is configured to delay relay of the signal until a second permitted time of the second timing grid.

Example 13: The system of Example 12, wherein the second permitted time is later than the first permitted time and wherein the second permitted time is an earliest permitted time of the second timing grid after the second node receives the signal.

Example 14: The system any of Examples 12-13, wherein the first timing grid and second timing grid are determined based on at least a shared operating frequency between the first node and the second node.

Example 15: The system of any of Examples 12-14, wherein the first timing grid or second timing grid is initialized based at least in part on receipt of a timing initialization signal by the first node or the second node.

Example 16: The system any of Examples 12-15, wherein the signal is relayed by the first node from a stored location.

Example 17: The system any of Examples 12-16, wherein the signal is received by the first node from another node in the communication network.

Example 18: A method of establishing a reference timing grid for a communication network, the method comprising: determining, for a first node in a communication network, an operating frequency; determining a reference time for a timing grid for the first node, determining a first set of permitted times the first node can perform a first set of actions on the timing grid; and transmitting, by the first node, a synchronizing signal to at least a second node in the communication network at the reference time.

Example 19: The method of Example 18 further comprising performing an action, by the first node, at a first time in the first set of permitted times.

Example 20: The method of Example 19 wherein the action comprises transmitting, by the first node, a communication signal to at least the second node at a first time in the first set of permitted times.

Example 21: The method of Example 20, wherein the communication signal comprises an (“RTS”) packet.

Example 22: The method of Example 19, wherein the action comprises transmission of a first signal to another node or cluster of nodes in the communication network.

Example 23: The method of any of Examples 18-22, wherein the operating frequency is a common operating frequency between a plurality of nodes in the communication network.

Example 24: The method of any of Examples 18-23, wherein the synchronization signal comprises a flag to begin the timing the timing grid.

Example 25: The method any of Examples 18-24, wherein a periodicity between permitted times of the timing grid is based on at least a geographic or communication distance between at least the first node and a different node in the communication network.

Example 26: The method any of Examples 18-25, further comprising determining a relaxed timing grid based on the timing grid, wherein the relaxed timing grid defines a second set of permitted times the first node can perform a second set of actions.

Example 27: The method of Example 26, further comprising: determining transmission wait period, the transmission wait period defining a delay between receiving a signal and transmitting in response to the signal; receiving a signal from the second node; and after the transmission wait period, transmitting a second communication signal to the second node at a time in the second set of permitted times.

Example 28: A method of operating a node cluster in a communication network, the method comprising, for a first node in the node cluster: determining a first set of permitted times to perform one or more actions, the one or more actions comprising at least transmission of a signal; receiving a communication from at least one other node in the communication network; determining a second set of permitted times to perform the one or more actions based at least in part on the communication, the second set of permitted times comprising a subset of the first set of permitted times; and performing an action of the one or more actions at a time in the second set of permitted times.

Example 29: The method of Example 28, wherein the at least one other node is outside of the node cluster.

Example 30: The method of any of Examples 28-29, wherein the action comprises transmitting a signal to at least one other node in the communication network.

Example 31: The method of Example 30, wherein the action comprises relaying the signal from a stored location.

Example 32: The method of any of Examples 28-31 further comprising, for the first node in the node cluster: determining a transmission wait period, the transmission wait period defining a delay between receiving a signal and transmitting in response to the received signal; receiving a first signal from a second node in the node cluster; and after the transmission wait period, transmitting a second signal to at a time in the second set of permitted times.

Example 33: A method of operating a distributed communication network, the method comprising, for each node in a node cluster of the distributed communication network: establishing a timing grid comprising a set of permitted times to transmit a signal, the timing grid comprising a shared spacing between permitted times with each other node in the node cluster; receiving a first signal; and transmitting a second signal to another node in the communication network at a time permitted by the timing grid.

Example 34: The method of Example 33, wherein the shared spacing between permitted times is based at least in part on an operating frequency of the node cluster.

Example 35: The method of any of Examples 33-34, wherein the shared spacing between permitted times is based at least in part on a timing initialization communication or signal received by the node in the node cluster.

Example 36: The method of Example 35, wherein the timing initialization communication is not a universal time reference or a reference clock input.

Example 37: A system for synchronizing transmission between nodes of distributed network, the system comprising: a first node of a plurality of nodes in a communication network, the first node comprising: a memory; an antenna; a transceiver; and one or more hardware processors configured to: determine permitted times the first node can perform an action; and perform the action at a permitted time of the timing grid.

Example 38: The system of Example 37, wherein the one or more hardware processors are configured to determine the permitted times without knowledge of a universal time reference or a reference clock input.

### J. Terminology

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics can be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

Embodiments of the disclosed systems and methods can be used and/or implemented with local and/or remote devices, components, and/or modules. The term “remote” may include devices, components, and/or modules not stored locally, for example, not accessible via a local bus. Thus, a remote device may include a device which is physically located in the same room and connected via a device such as a switch or a local area network. In other situations, a remote device may also be located in a separate geographic area, such as, for example, in a different location, building, city, country, and so forth.

Although described in the illustrative context of certain preferred embodiments and examples, it will be understood by those skilled in the art that the disclosure extends beyond the specifically described embodiments to other alternative embodiments and/or uses and obvious modifications and equivalents. Thus, it is intended that the scope of the claims which follow should not be limited by the particular embodiments described above.

What is claimed is:

1. A system for synchronizing transmission between nodes of a distributed network, the system comprising:
a first node of a plurality of nodes in a communication network, the first node comprising:
a memory;
an antenna;
a transceiver; and
one or more hardware processors configured to:
receive a timing initialization packet from a second node of the plurality of nodes;
determine an operating frequency;
determine a timing grid based at least in part on the timing initialization packet, wherein the timing grid comprises permitted times the first node can perform an action; and
perform the action at a permitted time of the timing grid.

2. The system of claim 1, wherein to determine the operating frequency, the one or more hardware processors are configured to perform operating frequency synchronization with the second node.

3. The system of claim 1, wherein the action comprises estimating at least one of: a time of arrival of the timing initialization packet, one or more parameters associated with one or more channels of the communication network, or a phase of arrival off the timing initialization packet.

4. The system of claim 1, wherein the action comprises calculating a received signal time.

5. The system of claim 1, wherein the action comprises transmission of a first packet to another node or cluster of nodes in the communication network.

6. The system of claim 5, wherein the first packet is received by the first node during a non-permitted time of the timing grid.

7. The system of claim 5, wherein the first packet is relayed by the first node from a stored location.

8. The system of claim 1, wherein the operating frequency is a common operating frequency between the plurality of nodes in the communication network.

9. The system of claim 1, wherein the timing initialization packet comprises a flagged time to begin the timing grid.

10. The system of claim 1, wherein a periodicity between permitted times of the timing grid is based on at least a geographic or communication distance between at least some of the plurality of nodes.

11. The system of claim 10, wherein an earliest in time permitted time of the timing grid occurs after a first period of the periodicity.

12. A method for synchronizing transmission between nodes of a distributed network, the method comprising:
receiving, by a first node of a plurality of nodes in a communication network, a timing initialization packet from a second node of the plurality of nodes;
determining an operating frequency;
determining a timing grid based at least in part on the timing initialization packet, wherein the timing grid comprises permitted times the first node can perform an action; and
performing the action at a permitted time of the timing grid.

13. The method of claim 12, wherein determining the operating frequency comprises performing operating frequency synchronization with the second node.

14. The method of claim 12, wherein the action comprises estimating at least one of: a time of arrival of the timing initialization packet, one or more parameters associated with one or more channels of the communication network, or a phase of arrival off the timing initialization packet.

15. The method of claim 14, wherein the action comprises calculating a received signal time.

16. The method of claim 12, wherein the action comprises transmission of a first packet to another node or cluster of nodes in the communication network.

17. The method of claim 16, wherein the first packet is received by the first node during a non-permitted time of the timing grid.

18. The method of claim 16, wherein the first packet is relayed by the first node from a stored location.

19. The method of claim 12, wherein the operating frequency is a common operating frequency between the plurality of nodes in the communication network.

20. The method of claim 12, wherein the timing initialization packet comprises a flagged time to begin the timing grid; and wherein a periodicity between permitted times of the timing grid is based on at least a geographic or communication distance between at least some of the plurality of nodes, a beginning of the periodicity at the flagged time.
